(19) United States
(12) Patent Application Publication
(10) Pub. No.: US 2018/0072269 A1
(43) Pub. Date: Mar. 15, 2018

(54) VEHICLE INTRUSION DETECTION VIA A SURROUND VIEW CAMERA

(71) Applicant: GM GLOBAL TECHNOLOGY OPERATIONS LLC, Detroit, MI (US)

(72) Inventors: Wei Tong, Troy, MI (US); Jinsong Wang, Troy, MI (US); Donald K. Grimm, Utica, MI (US); Thomas R. Brown, Shelby Township, MI (US); Mary E. Decaluwe, Oxford, MI (US); Carl W. Wellborn, Detroit, MI (US)

(21) Appl. No.: 15/261,048

(22) Filed: Sep. 9, 2016

(51) Int. Cl. B60R 25/30

(52) U.S. Cl. CPC B60R 25/305; B60R 2300/8073

(57) ABSTRACT

A method of detecting an intrusion includes sending an activation command to an intrusion detection system. In response to the activation command, at least one camera is activated. At least one image is obtained from the at least one camera representative of a surrounding area of the at least one camera. The at least one image is analyzed to determine if the intrusion is detected. An operator is then notified of the presence or absence of the intrusion.

### FIELD

The present disclosure relates generally to camera based driver assistance systems, and more particularly to vehicle intrusion detection via a surround view camera.

### INTRODUCTION

The statements in this section merely provide background information related to the present disclosure and may not constitute prior art.

Many modern vehicles include sophisticated electronic systems designed to increase the safety, comfort and convenience of the occupants. In order to enhance these systems, cameras have become increasingly popular as they can provide the operator of the vehicle with visual information about avoiding damage to the vehicle and/or obstacles that the vehicle might otherwise collide with. For example, many contemporary vehicles have a rear-view camera to assist the operator of the vehicle with backing out of a driveway or parking space. Forward-facing and side view camera systems have also been employed for vision based collision avoidance, clear path detection, and lane keeping systems.

### SUMMARY

A method of detecting an intrusion includes sending an activation command to an intrusion detection system. In response to the activation command, at least one camera is activated. At least one image is obtained from the at least one camera representative of a surrounding area of the at least one camera. The at least one image is analyzed to determine if the intrusion is detected. An operator is then notified of the presence or absence of the intrusion.

A method of detecting an intrusion includes activating at least one camera in response to an engine shut down. A plurality of images are obtained from the at least one camera and are representative of a surrounding area of the at least one camera. The plurality of images are compared to determine if the intrusion is detected. An operator is then notified of the presence or absence of the intrusion.

A vehicle intrusion detection system includes at least one camera for selectively obtaining images of a vehicle environment and at least one sensor for obtaining data from the vehicle environment. A controller for analyzing the obtained images and the sensor data is used to determine if an intrusion is present in the vehicle environment. Also included is a notification device for notifying a vehicle operator of the presence or absence of the intrusion in the vehicle environment.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a perspective view of a vehicle including a surround-view camera system having multiple cameras according to the present disclosure;

FIG. 2 is a perspective view of the vehicle of FIG. 1 arranged between two parked vehicles;

FIG. 3 is a block diagram for an exemplary activation method of the vehicle intrusion detection system according to the present disclosure; and

FIG. 4 is a block diagram for another exemplary activation method of the vehicle intrusion detection system according to the present disclosure.

### DETAILED DESCRIPTION

The following description is merely exemplary in nature and is not intended to limit the present disclosure, application, or uses. Furthermore, there is no intention to be bound by any expressed or implied theory presented in the preceding field, introduction, summary or the following detailed description. It should be understood that throughout the drawings, corresponding reference numerals indicate like or corresponding parts and features. Further, directions such as “top,” “side,” “back”, “lower,” and “upper” are used for purposes of explanation and are not intended to require specific orientations unless otherwise stated. These directions are merely provided as a frame of reference with respect to the examples provided, but could be altered in alternate applications. Conventional techniques and components related to vehicle electrical and mechanical parts and other functional aspects of the system (and the individual operating components of the system) may not be described in detail herein for the sake of brevity. It should be noted, however, that many alternative or additional functional relationships or physical connections may be present in an embodiment of the invention.

Additionally, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The following description also refers to elements or features being “connected” or “coupled” together. As used herein, these terms refer to one element/feature being directly or indirectly joined to (or directly or indirectly communicating with) another element/feature, but not necessarily through mechanical means. Furthermore, although the schematic diagrams shown herein depict example arrangements of elements, additional intervening elements, devices, features, or components may be present in an actual embodiment.

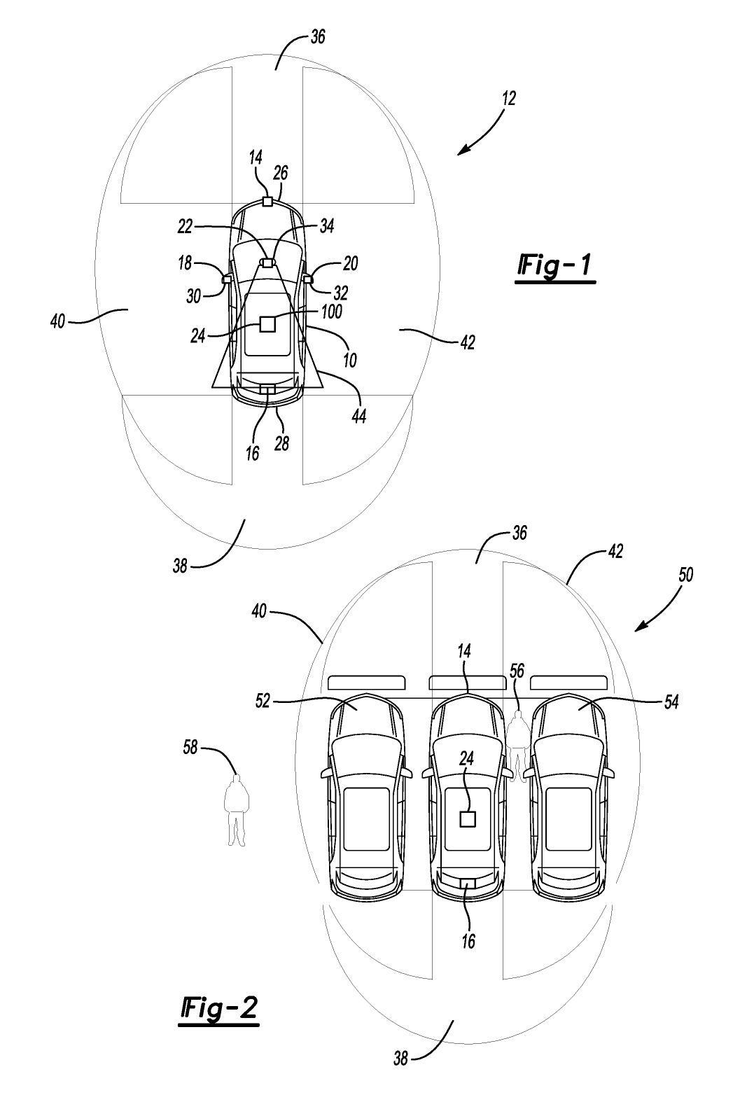

With reference now to FIG. 1, an exemplary host vehicle 10 having a vehicle intrusion detection system 100 according to a first embodiment is shown including a surround-view camera system 12 having one or more cameras. In one example, the surround-view camera system 12 includes a front-view camera 14; a rear-view camera 16; a left-side, driver view camera 18; a right-side, passenger view camera 20; and an interior camera 22. The surround-view camera system 12 can be used by the host vehicle 10 to perform multiple functions including, for example, back-up assistance, driver drowsiness or attentiveness determination, collision avoidance, structure recognition (e.g., roadway signs), etc. The existing surround-view camera system 12 can also be leveraged to inform a vehicle operator if an intruder is present inside or in close proximity to the host vehicle 10, as will be described in further detail below. The cameras 14, 16, 18, 20, 22 may be any type of camera suitable for the purposes described herein and should not be limited to only standard cameras presently available on automotive vehicles, for example, cameras capable of receiving light or other radiation and converting the energy to electrical signals in a pixel format using charged coupled devices.

With continued reference to FIG. 1, the cameras 14, 16, 18, 20, 22 can generate frames of image data at a certain data frame rate that can be stored for subsequent image processing. In some hardware embodiments, the image processing can be performed in a video processing module that may be a stand-alone unit or integrated circuit or may be incorporated into a controller 24. Alternatively in software embodiments, the video processing module may represent a video processing software routine that is executed by the controller 24.

The camera image data can be used to generate a top-down view of the vehicle and surrounding areas using the images from the surround-view camera system 12, where the images may overlap each other. In this regard, the cameras 14, 16, 18, 20, 22 can be mounted within or on any suitable structure that is part of the host vehicle 10, such as bumpers, fascia, grilles, mirrors, door panels, etc., as would be well understood and appreciated by those skilled in the art. Additionally, the cameras 14, 16, 18, 20, 22 may also be arranged solely externally or internally to the host vehicle 10 for viewing both the vehicle's exterior and interior (e.g., an interiorly arranged camera with visual range to see objects outside of the vehicle). In one non-limiting example, the front-view camera 14 is mounted near the vehicle grille 26; rear-view camera 16 is mounted on the vehicle endgate 28; side cameras 18 and 20 are mounted under the left and right outside rearview mirrors (OSRVM) 30, 32; and interior camera 22 is mounted within the inside rearview mirror (IRVM) 34. Furthermore, while the host vehicle 10 is shown having a surround-view system incorporating five cameras 14, 16, 18, 20, 22 at the described locations, the concepts from the present disclosure can be incorporated into vehicles having fewer or greater numbers of cameras or vehicles with cameras located elsewhere.

As previously discussed, the cameras 14, 16, 18, 20, 22 can be used to generate images of certain areas around the host vehicle 10 that partially overlap. Particularly, area 36 is the image area for the camera 14, area 38 is the image area for the camera 16, area 40 is the image area for the camera 18, area 42 is the image area for the camera 20, and area 44 is the image area for the camera 22. Image data from the cameras 14, 16, 18, 20, 22 is sent to the controller 24 where the image data can be stitched together with an algorithm that employs rotation matrices and translation vectors to orient and reconfigure the images from adjacent cameras so that the images properly overlap. The reconfigured images can then be used to check the surrounding and/or internal environment of the host vehicle 10 for further consideration in the controller 24.

With reference now to FIG. 2, the host vehicle 10 is located in a parking lot 50 with a vehicle 52 parked adjacent the driver side and a vehicle 54 parked adjacent the passenger side. The vehicle 52 is located within the area 40 and the vehicle 54 is located within the area 42. An animate object (e.g., intruder 56) is located between the vehicles 10, 54 and within the area 42, such that the intruder 56 cannot be seen by a vehicle operator 58 approaching the host vehicle 10.

In a first example, the vehicle operator 58 may remotely activate the vehicle intrusion detection system 100 in order to detect and inform the vehicle operator 58 if there are any animate objects within or in close proximity to the host vehicle 10. In this regard, the vehicle operator 58 may remotely check the surrounding and/or internal environment of the host vehicle 10 before entering the vicinity of the vehicle 10 so as to provide the vehicle operator 58 with peace-of-mind and personal safety. The vehicle intrusion detection system 100 may provide visual, haptic, or audio feedback to the vehicle operator 58 to indicate the presence of the intruder 56 within a predetermined range of the vehicle 10 (e.g., 1.5 meters). It is contemplated that the vehicle intrusion detection system 100 can be remotely activated through an input source, such as, a keyless entry remote (e.g., key FOB), a vehicle sensor (e.g., motion sensor, ultrasonic, anti-theft vibration sensor), an internet-based server application (e.g., ONSTAR REMOTELINK™ application), or any other passive entry/passive start system.

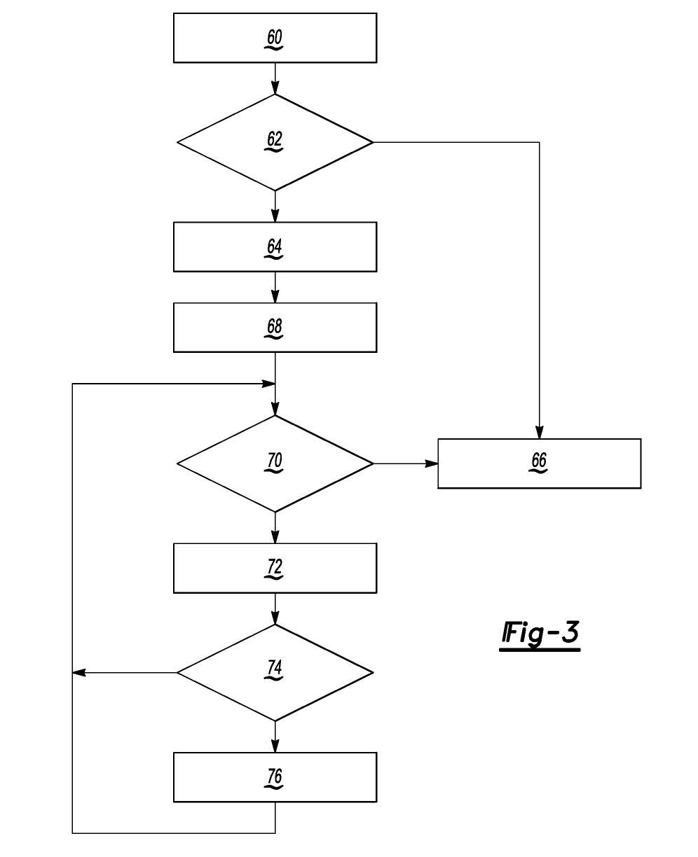

With reference now to FIG. 3, a block diagram of the activation of the vehicle intrusion detection system 100 before entering the vehicle 10 is described in detail. At step 60, a remote activation device (e.g., key FOB, ONSTAR REMOTELINK™) sends an activation command to the vehicle intrusion detection system 100. At step 62, the system 100 determines if the correct command for activation was sent. If the correct activation command has been sent, the controller 24 activates the cameras 14, 16, 18, 20, 22 and exterior detection systems (e.g., various vehicle sensors) at step 64. The sensors allow the system 100 to determine if a clear image can be obtained from the cameras 14, 16, 18, 20, 22 and, if required, the system 100 may activate exterior and/or interior lighting to provide better image clarity. If an incorrect activation command was sent, the command is discarded and the system 100 is shut down at step 66 in order to conserve vehicle power.

At step 68, a system timer is set (e.g., 5-10 minutes). If the time has elapsed at step 70, the system 100 times out and is shut down to conserve power. If the system timer indicates that time is remaining, the cameras 14, 16, 18, 20, 22 are commanded to obtain a surround-view and/or interior-view image of the vehicle 10 at step 72. Notably, sensor data (e.g., in-cabin infrared sensor or CO₂ sensor) may also be used in tandem with the camera images to provide detailed animate object analysis. The cameras 14, 16, 18, 20, 22 may utilize a low refresh rate (e.g., as low as one detection per user request) to analyze the vehicle perimeter and interior (e.g., at least areas 36, 38, 40, 42, 44) as the vehicle 10 is stationary at the time of detection. Furthermore, no localization of an object located in the perimeter is required, only a classification of the object as a human/potential intruder. In addition, there is no need for high resolution or real-time imagery as the environment will typically have consistent lighting and more static surroundings (i.e., due to being in a stationary mode).

The controller 24 then analyzes the data received from the vehicle sensors and the images from the cameras 14, 16, 18, 20, 22 and determines if an animate object (e.g., intruder 56) is within a predefined range of the vehicle 10, at step 74. If the intruder 56 is located within the predetermined range, results are conveyed to the vehicle operator 58 through either a stealth mode (e.g., captured images displayed on handheld device; key FOB blink, beep or vibration) or a non-stealth or alarm mode (e.g., vehicle horn activation; interior or exterior lights flashing) at step 76. After the detected image is conveyed to the vehicle operator 58, the system 100 returns to step 70 to verify if time has elapsed and continues to refresh the image obtained if time has not elapsed.

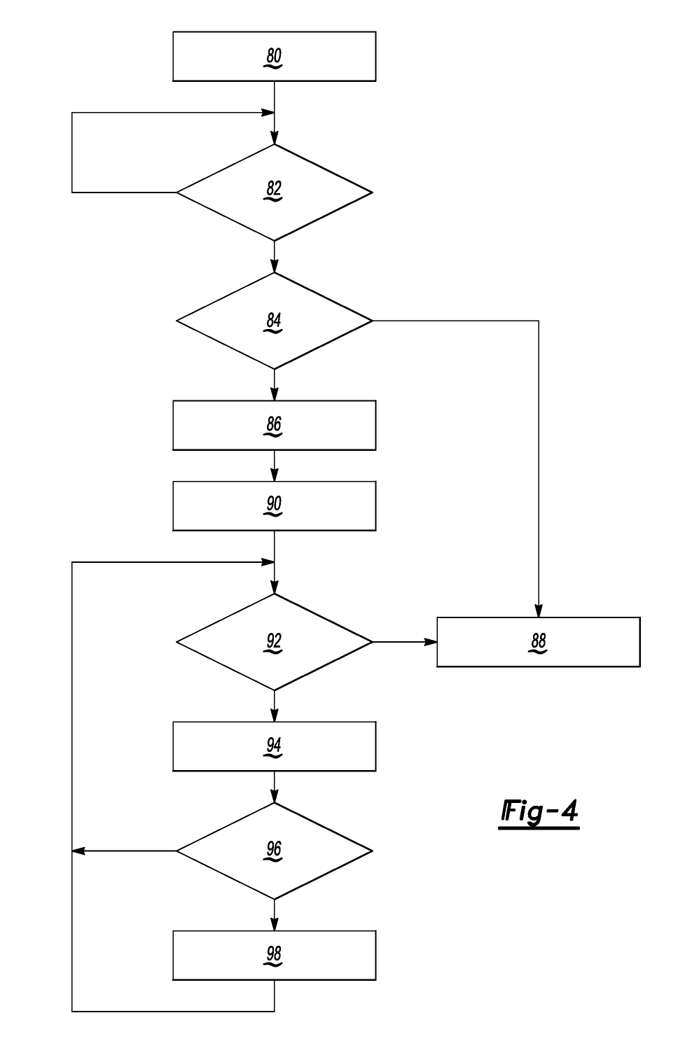

With reference now to FIG. 4, the vehicle intrusion detection system 100 may also be activated before the vehicle operator 58 exits the vehicle 10. In some circumstances, the vehicle operator 58 may want to verify surroundings before exiting the vehicle 10. In this case, at step 80, the vehicle operator 58 turns off the vehicle engine. At step 82, the system 100 determines if a predetermined time has elapsed since engine cessation, in order to maintain the vehicle's battery power. If not, the system 100 continues to loop until an appropriate time has elapsed. If the predetermined time has elapsed, the system 100 determines if the vehicle operator 58 is still inside of the vehicle 10, at step 84. If the operator 58 is still present in the vehicle 10, the controller 24 activates the cameras 14, 16, 18, 20, 22 and exterior detection systems (e.g., through various vehicle sensors) at step 86. The sensors allow the system 100 to determine if a clear image can be obtained from the cameras 14, 16, 18, 20, 22 and, if required, the system 100 may activate exterior and/or interior lighting to provide better image clarity. If the intruder 56 is located within the predetermined range, results are conveyed to the vehicle operator 58 through either a stealth mode (e.g., vehicle display, vehicle haptic alert, or captured images displayed on handheld device; key FOB blink, beep or vibration) or a non-stealth or alarm mode (e.g., in-vehicle audible alert, vehicle horn activation; interior or exterior lights flashing). If the operator 58 is no longer present in the vehicle 10, the command is discarded and the system 100 is shut down at step 88 in order to conserve vehicle power.

At step 90, a system timer is set (e.g., 5-10 minutes). If the time has elapsed at step 92, the system 100 times out and is shut down to conserve power. If the system timer indicates that time is remaining, the cameras 14, 16, 18, 20, 22 are commanded to obtain a surround-view and/or interior-view image of the vehicle 10 at step 94. Notably, sensor data (e.g., in-cabin infrared sensor or CO₂ sensor) may also be used in tandem with the camera images to provide detailed animate object analysis. The cameras 14, 16, 18, 20, 22 may utilize a low refresh rate (e.g., as low as one detection per user request) to analyze the vehicle perimeter and interior (e.g., at least areas 36, 38, 40, 42, 44) as the vehicle 10 is stationary at the time of detection. Furthermore, no localization of an object located in the perimeter is required, only a classification of the object as a human/potential intruder. In addition, there is no need for high resolution or real-time imagery as the environment will typically have consistent lighting and more static surroundings (i.e., due to being in a stationary mode).

The controller 24 then analyzes the data received from the vehicle sensors and the images from the cameras 14, 16, 18, 20, 22 and determines if an animate object (e.g., intruder 56) is within a predefined range of the vehicle 10, at step 96. If the intruder 56 is located within the predetermined range, results are conveyed to the vehicle operator 58 through either a stealth mode (e.g., captured images displayed on handheld device; key FOB blink, beep or vibration) or a non-stealth or alarm mode (e.g., vehicle horn activation; interior or exterior lights flashing) at step 98. After the detected image is conveyed to the vehicle operator 58, the system 100 then returns to step 82 to verify if time has elapsed and continues to refresh the image obtained if time has not elapsed.

By using the vehicle intrusion detection system 100 as a passive system or on-demand system, there is no power drain from the battery while the system remains inactive. Furthermore, the vehicle intrusion detection system 100 can be run as an application in the controller 24, as the majority of other vehicle operations are not typically running during the vehicle's inactive phase. In this way, computational resources can be reduced leading to low computation hardware requirements. Alternatively, the vehicle intrusion detection system 100 may be an active system that remains in low power state for a predetermined time period (e.g., an hour after vehicle has ceased operating).

As should be understood, image detection can occur through a variety of complementary methods. In one example, a computer vision and machine learning method, such as, deep learning-based recognition can be utilized for human/intruder detection from stationary images. As the nature of this method is simpler than the common images-based object detection for deep learning, a relatively simple network can be implemented in a number of embedded platforms with very low power consumption.

In another example, motion detection can be used as a complement to stationary object detection. In motion detection, even subtle movement can be detected through comparing pixel values in consecutive image frames. Essentially, if an object is moving the corresponding pixel values in consecutive frames changes significantly and can be quantified to detect object movement. In yet another example, an analysis of exposure gains in the cameras 14, 16, 18, 20, 22 can yield information for image recognition/object classification. In particular, when an object is located very close to a particular camera lens (e.g., an intruder 56 blocking the lens), the gain value of that camera is significantly different from the gain values of the remaining cameras. A comparison of the gain values at each camera can lead to a determination that something or someone is blocking the lens at a particular zone around the vehicle 10. As should be understood, each of these detection methods can be used alone or in combination to yield appropriate image detection.

According to the exemplary embodiments, the present disclosures affords the advantage of providing the vehicle operator 58 with virtual images of surroundings in order to identify any potential intruders 56 that the vehicle operator 58 may want to avoid. The camera modeling may be performed by a processor or multiple processors employing hardware and/or software. While not described in detail herein, it is also contemplated that the vehicle 10 may utilize vehicle-to-vehicle (V2V) communication in order to increase the range of the system 100 to areas otherwise blocked by existing vehicles (e.g., locations beyond vehicles 52, 54, intruders located in adjacent vehicles). In particular, each of the vehicles 10, 52, 54 could be networked together. In this way, an intruder detection request at one of the vehicles would wake up nearby parked vehicles having surround view detection capability and render the results to the vehicle operator 58. The nearby parked vehicles will provide the vehicle operator 58 with information about any potential intruders at or near their vehicle.

As will be well understood by those skilled in the art, the several and various steps and processes discussed herein to describe the invention may be referring to operations performed by a computer, a processor or other electronic calculating device that manipulate and/or transform data using electrical phenomenon. Those computers and electronic devices may employ various volatile and/or non-volatile memories including non-transitory computer-readable medium with an executable program stored thereon including various code or executable instructions able to be performed by the computer or processor, where the memory and/or computer-readable medium may include all forms and types of memory and other computer-readable media.

Embodiments of the present disclosure are described herein. This description is merely exemplary in nature and, thus, variations that do not depart from the gist of the disclosure are intended to be within the scope of the disclosure. For example, the disclosure may also be utilized in non-automotive environments, such as general home security or with industrial applications (e.g., clearance for moving equipment).

The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for various applications. Various combinations and modifications of the features consistent with the teachings of this disclosure, however, could be desired for particular applications or implementations.

What is claimed is:

1. A method of detecting an intrusion, comprising:
sending an activation command to an intrusion detection system;
activating at least one camera in response to the activation command;
obtaining at least one image from the at least one camera representative of a surrounding area of the at least one camera;
analyzing the at least one image to determine if the intrusion is detected; and
notifying an operator of the presence or absence of the intrusion.

2. The method of detecting the intrusion of claim 1, further comprising:
determining, at the intrusion detection system, if the activation command is a correct or incorrect activation command; and
shutting down the intrusion detection system when the activation command is the incorrect activation command.

3. The method of detecting the intrusion of claim 1, further comprising:
activating at least one exterior detection system in response to the activation command; and
analyzing data received from the at least exterior detection system to determine if the intrusion is an animate object within a predefined range.

4. The method of detecting the intrusion of claim 1, wherein analyzing the at least one image further comprises:
activating at least one of interior or exterior lighting to improve image clarity.

5. The method of detecting the intrusion of claim 1, wherein the step of notifying the operator is completed in a stealth mode.

6. The method of detecting the intrusion of claim 5, wherein the stealth mode includes at least one of displaying the at least one image to the operator, sending a visual notification to the remote activation device, sending a tactile notification to the remote activation device, or sending an auditory notification to the remote activation device.

7. The method of detecting the intrusion of claim 1, wherein the step of notifying the operator is completed in an alarm mode.

8. The method of detecting the intrusion of claim 7, wherein the alarm mode includes at least one of activating a horn, flashing a light, illuminating exterior colors, or sounding an alarm.

9. The method of detecting the intrusion of claim 1, wherein obtaining the at least one image further comprises:
obtaining a first image from the at least one camera;
obtaining a second image from the at least one camera; and
comparing the first and second images to determine if the intrusion is detected.

10. A method of detecting an intrusion, comprising:
activating at least one camera in response to an engine shut down;
obtaining a plurality of images from the at least one camera representative of a surrounding area of the at least one camera;
comparing the plurality of images to determine if the intrusion is detected; and
notifying an operator of the presence or absence of the intrusion.

11. The method of detecting the intrusion of claim 10, further comprising:
activating at least one exterior detection system in response to the engine shut down; and
analyzing data received from the at least one exterior detection system to determine if the intrusion is an animate object within a predefined range.

12. The method of detecting the intrusion of claim 10, wherein comparing the plurality of images further comprises:
activating at least one of interior or exterior lighting to improve image clarity.

13. The method of detecting the intrusion of claim 10, wherein the step of notifying the operator is completed in a stealth mode.

14. The method of detecting the intrusion of claim 13, wherein the stealth mode includes at least one of displaying the plurality of images to the operator, sending a visual notification to a remote activation device or to an in-vehicle display, sending a haptic notification to the remote activation device or to the in-vehicle display, sending an auditory notification to the remote activation device, or automatically locking a vehicle door.

15. The method of detecting the intrusion of claim 10, wherein the step of notifying the operator is completed in an alarm mode.

16. The method of detecting the intrusion of claim 15, wherein the alarm mode includes at least one of activating a horn, flashing a light, or sounding an alarm.

17. A vehicle intrusion detection system comprising:
at least one camera for selectively obtaining images of a vehicle environment;
at least one sensor for obtaining data from the vehicle environment;
a controller for analyzing the obtained images and the sensor data to determine if an intrusion is present in the vehicle environment; and
a notification device for notifying a vehicle operator of the presence or absence of the intrusion in the vehicle environment.

18. The vehicle intrusion detection system of claim 17, wherein the controller analyzes the obtained images through at least one of a computer vision and machine learning method, a motion detection method, and an exposure gain method.

19. The vehicle intrusion detection system of claim 17, wherein the sensor detects the presence of an animate object within the vehicle environment.

20. The vehicle intrusion detection system of claim 17, wherein the at least one camera and the at least one sensor are activated via one of a remote activation device and an engine shut down.
